(19) United States
(12) Patent Application Publication
(10) Pub. No.: US 2001/0013184 A1
(43) Pub. Date: Aug. 16, 2001

(54) METHOD OF EXHIBITING DYNAMIC PICTURES ON FIXED STANDS TO SPECTATORS WHO ARE TRAVELING AT AN INCREASING -ACCELERATION- AND/OR CONSTANT AND/OR DECREASING -DECELERATION- RATE OF MOVEMENT, AND A STATIC-FILM DEVICE TO EXHIBIT IMAGES ACCORDINGLY

(76) Inventor: JUAN MARTIN BADARACCO, LA LUCILA (AR)

Correspondence Address: KENNETH F FLOREK, HEDMAN GIBSON & COSTIGAN, 1185 AVE OF THE AMERICAS, NEW YORK, NY, 10036

(21) Appl. No.: 09/065,625

(22) Filed: Apr. 24, 1998

(51) Int. Cl. G09F 19/14

(52) U.S. Cl. 40/453

(57) ABSTRACT

A system that allows static posters set in subway or train tunnel to be seen as a movie short through the combination of a moving train traveling at a constant or different speeds and a set of posters set on the tunnel walls.

### CROSS-REFERENCE TO RELATED APPLICATIONS

Not Applicable

### STATEMENT REGARDING FEDERALLY SPONSORED RESEARCH OR DEVELOPMENT

Not Applicable

### REFERENCE TO A MICROFICHE APPENDIX

Not Applicable

### BACKGROUND OF THE INVENTION

The present invention consists of a static-film device which exhibits a moving image through fixed pictures to passengers on a moving train. Specifically this invention has been designed to exhibit advertising shorts to subway passengers.

There is an important period of time while the subway travels through the tunnel when the passengers don't have much choice but to watch the posters they've got in front of them. Another alternative is to look outside, to the darkness of the tunnel, thus there exists an important margin, measured in terms of passenger minutes, in this totally wasted advertising medium.

The present invention gives a solution to this gap, through a device known as static-film. It is static in the sense that a series of fixed posters are attached to the tunnel's walls but in their totality and with the aid of the moving train, provide the passengers with moving images as in a film.

### BRIEF SUMMARY OF THE INVENTION

This invention is directed to expose passengers on a moving train (such as a subway) to movie shorts through fixed panels set on the tunnel's walls. The object of the present invention is to recreate dark tunnels into advertisement space through a system that allows static posters to become a movie short.

According to this invention, a series of posters are placed one beside the other parallel to the direction the train is traveling. Each poster exhibits a static image but with the aid of the poster next to it, the movie effect is obtained. To fix the poster image on the passenger's retina, the posters are lit during a short interval of time, determined by the speed of ocular retention.

### BRIEF DESCRIPTION OF THE SEVERAL VIEWS OF THE DRAWING

FIG. 1 is a diagram in perspective which shows a train going through a subway tunnel. The static-film device is also displayed.

FIG. 2 is a raised diagram of the static-film device which appears in FIG. 1. Its purpose is to show the spatial and dimensional interrelation between the posters.

### DETAILED DESCRIPTION OF THE INVENTION

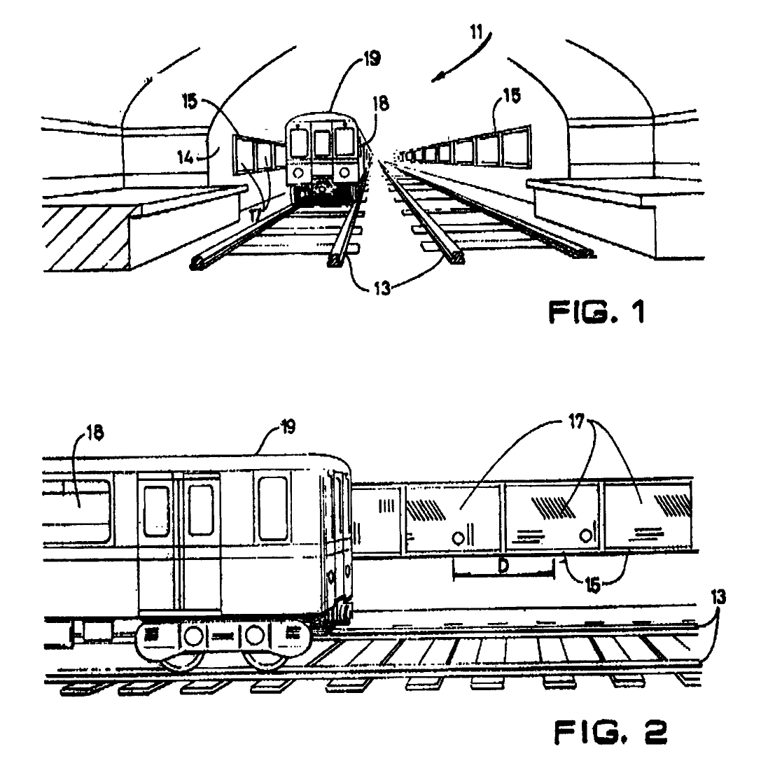

To describe in detail how the invention previously described can be put into practice, FIGS. 1 and 2 show a subway tunnel (11) with the corresponding ascending and descending tracks (13) in whose walls (14) are fixed a sequence of posters (15) at the same height as the windows (18) of the train (19) which go through the tracks(13). Each poster (15) displays a static picture (17) which forms part of a dynamic sequence.

As is already known, the human eye assimilates visual stimuli at a constant rate not greater than 1/12 of a second. This, therefore, is the maximum interval which we can allow to pass from one image (17) to the next.

In this presentation, the instant represented by the picture (17) in each poster (15) is out of sync T in 1/24 seconds by the previous one, in the constant traveling direction V of the train (19). Furthermore, the longitudinal interval or distance D from center to center between the adjacent posters (15) is equal to the distance covered by the train (19) in an equivalent time interval. We consider therefore that the train (19) travels at a predetermined speed which is constant. The train (19) travels along this part of the tunnel (11) at a nominal constant speed of 50 Km per hour. According to one of the premises of this method, the posters (15) are distributed along the tunnel (11) at D intervals of:

D=V×T=50 Km p/hr×1/24 sec=0.58 meters approx.

This D measure includes the width of the image (17) and a blank space in between posters (15) of 58 cm in total, for example.

Of course, the intervals from one poster (15) to another can be submultiples of the maximum D interval calculated above, in case images of smaller dimensions are necessary, so that the total image is visible and takes up the passengers' line of sight inside the train (19). A decisive parameter to determine the size of the images is the distance between the tracks (13) and the wall (14).

The image of the poster (15) for this project involves a 35 mm film, leaving a proportional space to the one that exists between the picture frames. The H height of the posters is determined on the basis of the relationship with the picture frame.

The reel of posters (15) extends itself lengthwise along the wall (14) according to the duration of the static-film presentation, within the maximum stretch available inside the tunnel where the train travels at a constant speed. Even though sections close to stations where the train accelerates or brakes can be included, this demands searching for the right image according to the time that has passed since the commencement of the short, in a uniformly accelerated movement; or changing the amount of frames per second, knowing that the pupil accepts up to 12 frames per second. This would also require that all trains comply with the movement in the same manner This last problem doesn't appear within the section of constant speed in the middle of the tunnel, given that subways usually run at the same speed V of 50 Km per hour, at least in the city of Buenos Aires. Consequently, we shall explain it on a separate section.

In the present case, the images (17) refer to an advertising short of a 30 seconds duration At (advertising time), the posters (15) covering a stretch Al (Advertising length) inside the tunnel (11).

Now if we added to the said movement the acceleration and deceleration period A, considering that A is continuous and approximately 0.85 meters per second squared, and knowing that the maximum speed V is 50 Km per hour and the and the stretches Lp′ in A.

Tp′=(V/A−V′/A)×2minimum V′ to put up posters is 25 Km per hour, we will be able to determine the times Tp′

Tp′=(13.89 m/sec./0.85 m/sec.²−6.94 m/sec./0.85 Ms./sec.²)×2=

Lp′=½×V/A)−(½×V′/A)×2

Lp′=(0.5×(13.89 m/sec.)/0.85 m/sec.²)−(0.5×6.94 m/sec.) /0.85 m/sec.²)×2=170.3159 meters.

That is to say, the Lp′ distance of the short between the acceleration and deceleration periods will be of approximately 170 meters, and the duration of 16.3529 seconds. Consequently, if the duration of the short is of 30 seconds, this means that the time T″ that must be covered at a constant speed will be that of the total duration of the short minus the time T′; and the distance Lp″ will be:

T″=30 sec.−16.3529 sec.=13.6471 sec.

Lp″=V×T″

Lp″=13.89 m/sec.×13.6471 sec.=189.558219 meters

In other words, to set up an advertising short of 30 seconds duration. a roll of approximately 359.8741 meters is installed on the wall (14), consisting of about 720 posters (15).

On the other hand, to fix the image on the passengers' retina as the train (19) goes through the tunnel (11), it is necessary that each picture (17) remain lighted only a fraction of the time interval T that the train (19) passes in front of the poster (15). This can be achieved providing the posters (15) with a quick lighting mechanism; for example laser lamps commuted to T periods. Preferably, the brief lighting period can be controlled by a timer commanded by a device which captures the passing of the train (19), in order to synchronize the turning-on of each poster (15) as the train (19) passes in front of each picture (17).

What I claim as my invention is:

1. A method of exhibiting dynamic pictures on fixed stands to spectators who are traveling at increasing (acceleration) and/or constant and/or decreasing (deceleration) rate of movement, and a static-film device to exhibit images accordingly.
